(19) United States
(12) Patent Application Publication
(10) Pub. No.: US 2010/0324964 A1
(43) Pub. Date: Dec. 23, 2010

(54) AUTOMATICALLY MONITORING WORKING HOURS FOR PROJECTS USING INSTANT MESSENGER

(75) Inventors: Sean Callanan, Churchtown (IE); Al Chakra, Apex, NC (US); Muhammad Afan Shah, Mulhuddart (IE); Smriti Talwar, Mulhuddart (IE)

Correspondence Address: IBM RALEIGH IPLAW (DG);C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/487,939

(22) Filed: Jun. 19, 2009

(51) Int. Cl. G06Q 10/00

(52) U.S. Cl. 705/9; 705/32; 705/8

(57) ABSTRACT

An automatic work monitoring system may be implemented in an instant messaging application so that employee hours can automatically be tracked and associated with projects. The work monitoring system can determine that an activity is associated with a project based on context of the activity and an employee's work profile. The work monitoring system can determine the amount of time spent on the activity and record the amount of time in a daily work record. The work monitoring system can also update the employee's presence information to indicate that the employee is working on the project to update the employee's instant messaging contacts about the employees work activity.

### BACKGROUND

Embodiments of the inventive subject matter generally relate to the field of employee time monitoring, and more particularly to automatically monitoring working hours for projects using instant messenger.

Tracking working hours of employees with respect to projects assigned to the employees is important for many types of businesses. For example, government contractors are required to report employee's hours for different tasks within a project. Many timekeeping systems allow employees to manually track their hours for different projects. At the end of the day, an employee can select a project and manually record the total amount of time worked on the project.

### SUMMARY

Embodiments include a method directed to retrieving a work profile in response to a request from an employee to sign in to an instant messenger application. In some embodiments, a plurality of applications that should be monitored can be determined based on the work profile. An activity in a first of the plurality of applications can be detected. If the activity should be associated with a project indicated in the work profile, an amount of time that the employee worked on the project can be computed based on a start time and an end time of the activity. An amount of time and an identifier of the project can be recorded in a daily work record.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram of automatically monitoring time associated with projects.

FIG. 2 depicts a flowchart of example operations for automatically monitoring time associated with projects.

FIG. 3 depicts a flowchart of example operations for associating activities with projects.

FIG. 4 depicts a flowchart of example operations for associating activities with projects.

FIG. 5 depicts an example conceptual diagram of an architecture for automatically monitoring time associated with projects.

FIG. 6 depicts a flowchart of example operations for automatically managing overtime.

FIG. 7 depicts an example computer system.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to instant messaging, embodiments may be implemented such that more contextual information from calendar and other applications is gathered. For example using meeting, appointment, reminder, and events information from a calendar, activity can be associated with projects in a daily work report. In other instances, well-known instruction instances, protocols, structures, and techniques have not been shown in detail in order not to obfuscate the description.

Manual timekeeping may be inaccurate if an employee forgets what time the employee started or stopped a project task or if employees do not record their time consistently. Manual timekeeping systems may not provide real-time information to employees or managers. For example, employees are not warned when the employees are reaching work hour limits (e.g., daily time maximums, weekly time maximums, project budget limits, etc.). As another example, managers cannot readily determine which projects employees are working on. An automatic work monitoring system may be implemented in an instant messaging application so that employee hours can automatically be tracked and associated with projects. The work monitoring system can determine that an activity is associated with a project based on context of the activity and an employee's work profile. The work monitoring system can determine the amount of time spent on the activity and record the amount of time in a daily work record. The work monitoring system can also update the employee's presence information to indicate that the employee is working on the project to update the employee's instant messaging contacts about the employee's work activity. The employee's presence information indicates the ability and willingness of the employee to communicate with others. Updating the presence information to indicate that the employee is working can indicate that the employee is busy and therefore not available for communication.

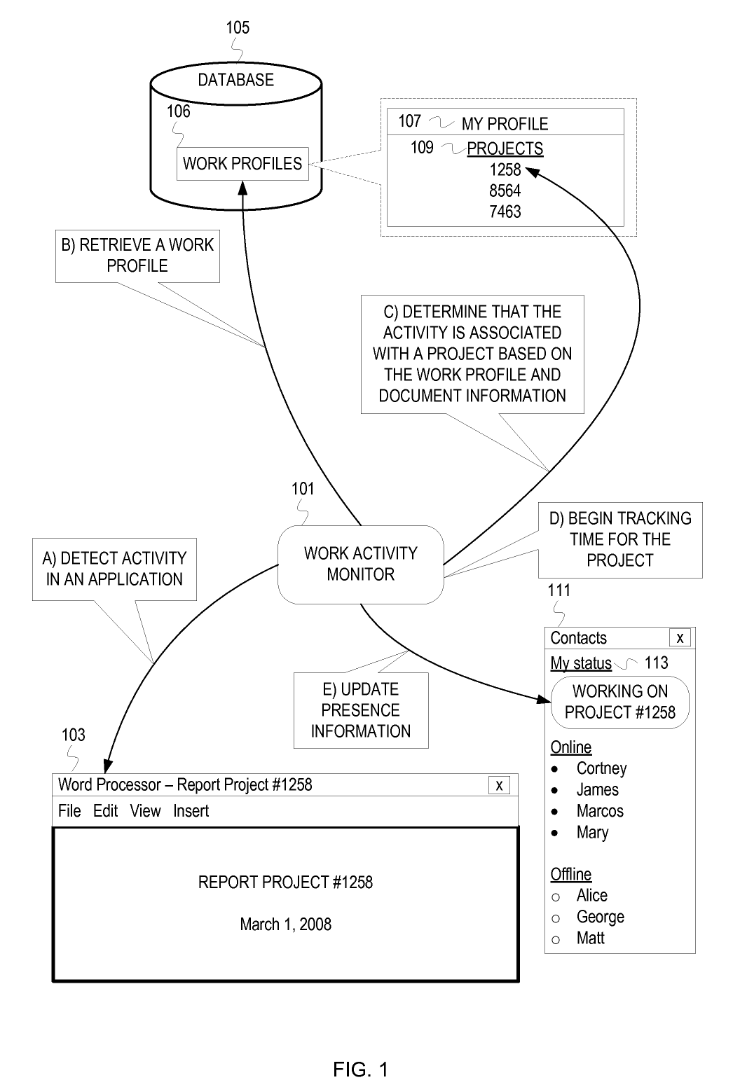

FIG. 1 depicts an example conceptual diagram of automatically monitoring time associated with projects. FIG. 1 shows dataflow and operations occurring in stages A-E. At stage A, a work activity monitor 101 detects activity in an application. Detecting activity comprises monitoring applications for file accesses, network accesses, mouse movements, keystrokes, etc. Examples of activities include creating a document, editing a document, composing an email, participating in a web conference, instant messaging, etc. In this example, the work activity monitor detects creation of a new document in a word processor 103. The work activity monitor 101 may be integrated in the instant messenger 111, a plug-in to the instant messenger 111, a standalone application, a plug-in to another application, etc.

At stage B, the work activity monitor 101 retrieves a work profile 107 from a database 105. The work profile 107 can indicate projects 109 that have been assigned to an employee. In this example, the employee is assigned three projects, project 1258, project 8564, and project 7463. The work profile 107 can also indicate rules for associating activity with projects. For example, a rule may indicate certain files are associated with a certain project. As another example, a rule may indicate that correspondence with a particular contact is associated with a particular project. The database 105 can be hosted on a network server. In addition, the work profile 107 may be cached on a local machine when the employee logs into an instant messenger 111.

At stage C, the work activity monitor determines that the activity is associated with the project 1258 based on the work profile 107 and document information. In this example, the work activity monitor 101 determines that the activity is associated with the project 1258 based on the project number found in the word processing document's title. The work activity monitor 101 may also determine that the activity is associated with the project 1258 based on document text (see 103).

At stage D, the work activity monitor 101 begins tracking time for the project. For example, the work activity monitor 101 starts a counter. As another example, the work activity monitor 101 records a time stamp indicating the activity start time in a daily work report.

At stage E, the work activity monitor 101 updates presence information of the employee to indicate that the employee is working on project 1258. The presence information can be displayed to the employee to allow the employee to verify that the activity has been associated with an appropriate project. In this example, the employee's instant messenger status 113 is updated to display “Working on Project #1258.” As another example, the employee may be prompted with: “Document ‘Report Project #1258’ has been associated with ‘project 1258.’ Is this correct?” The employee can choose “Yes” or “No.” If the employee chooses “No,” a list of projects in the work profile may be displayed for the employee to choose the appropriate project. The presence information can also be displayed to the employee's instant messaging contacts. For example, the employee's status may be displayed as “Working on project 1258” in to the employee's contacts.

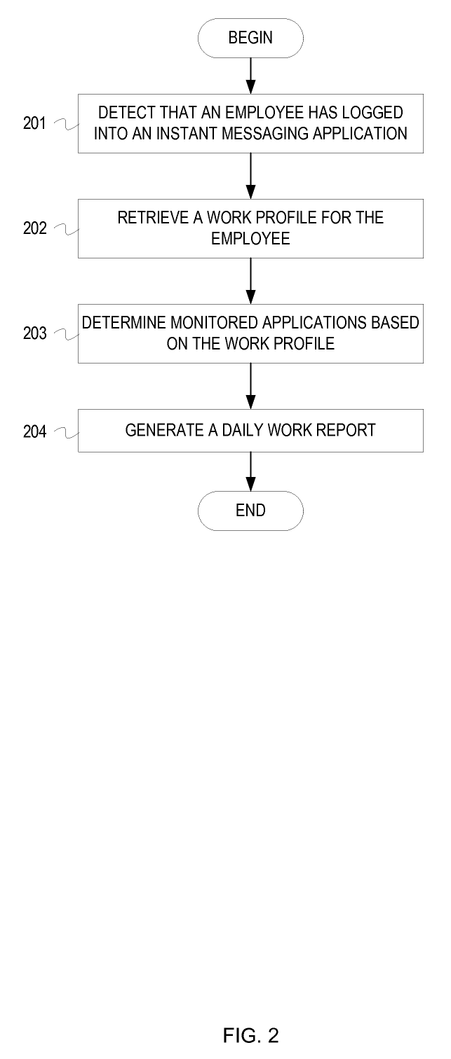

FIG. 2 depicts a flowchart of example operations for automatically monitoring time associated with projects. Flow begins at block 201, where a work activity monitor detects that an employee has logged into an instant messaging application.

At block 202, the work activity monitor retrieves a work profile for the employee. The work profile comprises information about projects assigned to the employee, an indication of applications that should be monitored for possible activity associated with the projects (“monitored applications”), rules for associating activities with projects, overtime rules, etc. Examples of monitored applications include word processors, spreadsheet editors, email clients, calendar applications, database editors, instant messengers, conferencing applications, etc. Flow continues at block 203.

At block 203, the work activity monitor determines the monitored applications based on the work profile. For example, the work profile indicates that Microsoft® Word, Microsoft Outlook, and WebEx®. The work activity monitor can initiate agents to monitor activity in the monitored applications. Examples of agents include file access agents, network access agents, mouse movement agents, keystroke agents, etc. The agents may be part of the work activity monitor, applications, integrated in an instant messenger application, plug-ins to the instant messenger application, plug-ins to other applications, etc. For example, a file access agent detects that a document has been opened in a word processor. As another example, a mouse movement agent detects that an employee started a chat with an instant messaging contact based on detecting a double click on the instant messaging contact's name. Flow continues at block 204.

At block 204, the work activity monitor generates a daily work report and flow ends. The work activity monitor uses the daily work report to record the employee's time worked on projects. The daily work report comprises a report identifier, a total time worked, a number of hours to carry over to the next day, amount of overtime requested, amount of overtime worked, total time worked on each project.

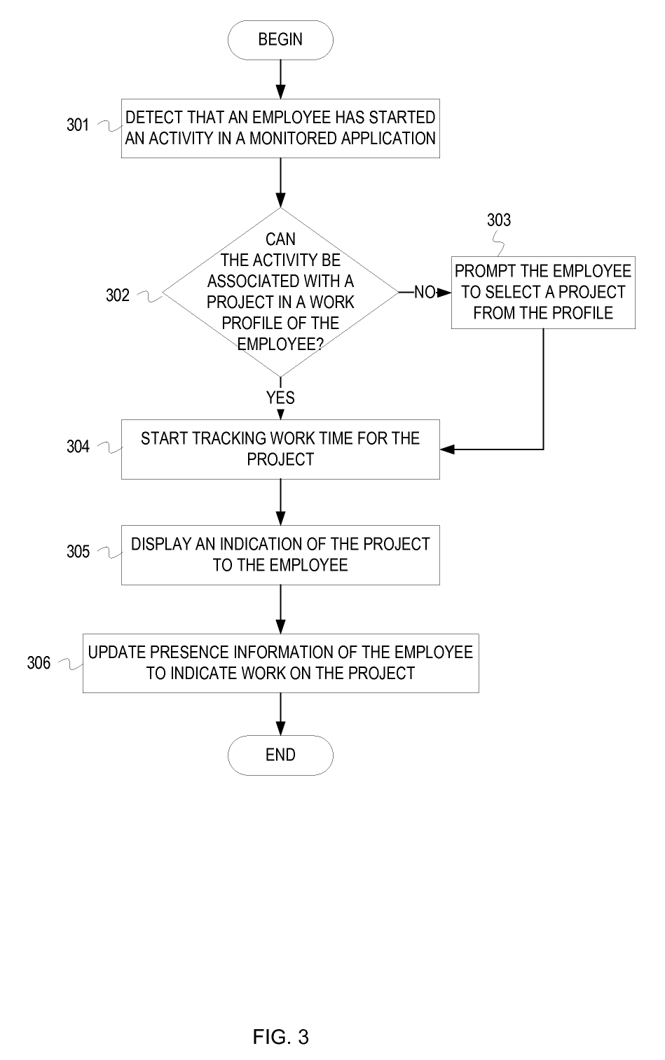

FIG. 3 depicts a flowchart of example operations for associating activities with projects. Flow begins at block 301, where a work activity monitor detects that an employee has started an activity in a monitored application. For example, the work activity monitor detects that the employee is composing an email. As another example, the work activity monitor determines that the employee joined a web conference. Flow continues at block 302.

At block 302, the work activity monitor determines if the activity can be associated with a project in a work profile of the employee based on context of the activity. For example, the work activity monitor detects start of a meeting based on the employee's calendar. The activity monitor determines that the meeting is associated with a project_X based on the text “project_X” in the meeting subject. As another example, the employee begins chatting with an instant messaging contact. The work activity monitor determines that the chat is associated with a project_Y based on the information in the work profile indicating the contact is associated with project_Y. If the activity cannot be associated with a project in the work profile, flow continues at block 303. If the activity can be associated with a project in the work profile, flow continues at block 304.

At block 303, the work activity monitor prompts the employee to select a project from the profile. For example, the activity monitor determines that the employee created a new word processing document. Because the new document does not contain any information that can be associated with a project, the work activity monitor prompts the employee to select a project. The work activity monitor can add association rules to the employee profile based on selections by the employee. For example, the work activity monitor adds an association rule to the work profile that indicates that the new document should be associated with the project. As another example, the work activity monitor adds an association rule to associate a particular contact with a project because the employee only interacts with the particular contact in regards to the project. In addition, the employee can select an option that does not associate the activity to any project. Flow continues at block 304.

At block 304, the work activity monitor begins tracking work time for the project. For example, the work activity monitor starts a timer. Flow continues at block 305.

At block 305, the work activity monitor displays an indication of the project to the employee. The display may be active. For example, the work activity monitor displays the project and prompts the employee to verify that the employee wishes to have time tracked for that project. The display may be passive. For example, the work activity monitor can display “Tracking time for the project” at the top of an application window. The employee can click on the display to change the project or stop time tracking. Flow continues at block 306.

At block 306, the work activity monitor updates presence information of the employee to indicate work on the project and flow ends. For example, the employee's instant messaging status is changed to reflect that the employee is working on the project. The employee's instant messenger contacts can determine that the employee is working on the project by viewing the employee's status.

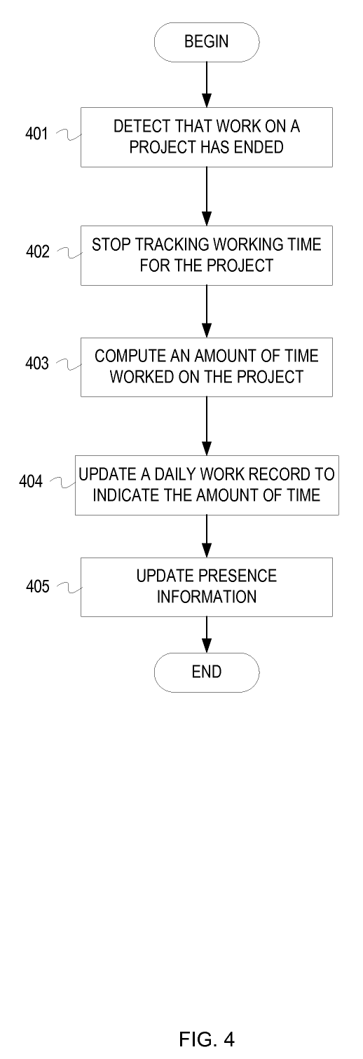

FIG. 4 depicts a flowchart of example operations for associating activities with projects. Flow begins at block 401, where a work activity monitor detects that work on a project has ended. For example, an employee closes a spreadsheet. As another example, the employee exits a web conference. As another example, the employee opens a word processor document associated with another project. Flow continues at block 402.

At block 402, the work activity monitor stops tracking work for the project. For example, the work activity monitor stops a timer. As another example, the work activity monitor records a time stamp in a daily work record. The work activity monitor may display an alert message before the work activity monitor stops tracking. Flow continues at block 403.

At block 403, the work activity monitor computes an amount of time worked on the project. For example, the work activity monitor determines the amount of time based on a timer. As another example, the work activity monitor subtracts a start time stamp from an end time stamp. Flow continues at block 404.

At block 404, the work activity monitor updates a daily work record to indicate the amount of time worked. The work activity monitor can record an identifier of the project and the amount of time worked in the daily work record. Flow continues at block 405.

Daily work records can be compiled for payroll, billing reporting, etc. Employees can use compiled daily work records to determine the hours they \worked on certain projects over time. Mangers can use the daily work records to determine employee productivity, bill customers, etc. The daily work records may be stored on a local machine and may be backed up in a database that stores the work profiles.

A work profile may indicate conditions that can cause work tracking to be stopped. For example, company policy may prohibit employees from visiting a music website. If the work activity monitor detects that an employee is visiting the music website, the work activity monitor may stop tracking working time while the employee is visiting the website. As another example, the work profile may indicate a threshold for keyboard and/or mouse inactivity. If an employee exceeds the threshold, the work activity monitor may stop tracking working time until the employee resumes keyboard and/or mouse activity.

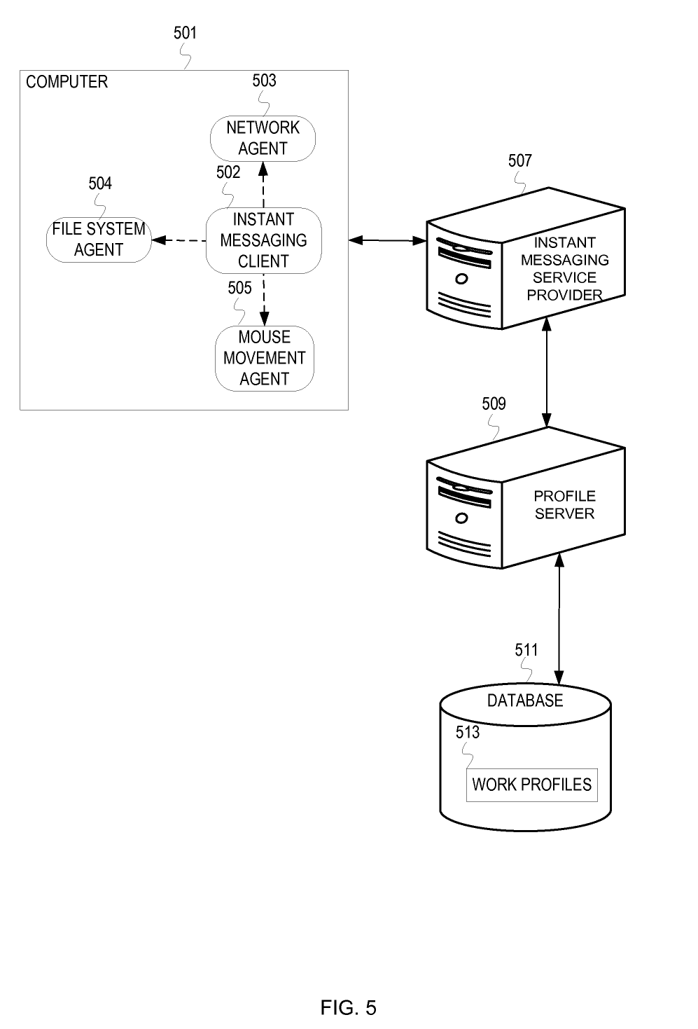

FIG. 5 depicts an example conceptual diagram of an architecture for automatically monitoring time associated with projects. An computer 501 is communicatively coupled to an instant messaging service provider 507. The instant messaging service provider 507 is communicatively coupled with a profile server 509. The profile server is connected to a database 511. The database 511 stores work profiles 513

The computer 501 hosts an instant messaging client 502. The instant messaging client can detect activity, determine if the activity can be associated with a project, and track time for the project if the activity is associated with the project. The instant messaging client 502 can utilize network agent 503, file system agent 504, and mouse movement agent 505 to detect activity.

The instant messaging service provider 507 can serve instant messaging content (e.g., contact list, contact status, contact profiles, instant messages) to the instant messaging client 502. The instant messaging service provider 507 can retrieve the work profiles 513 from the profile server 509 on behalf of the instant messaging client 502 and can return the work profiles 513 to the instant messaging client 502.

The profile server 509 can retrieve the work profiles 513 from the database 511 and can return the work profiles to the instant messaging service provide 507.

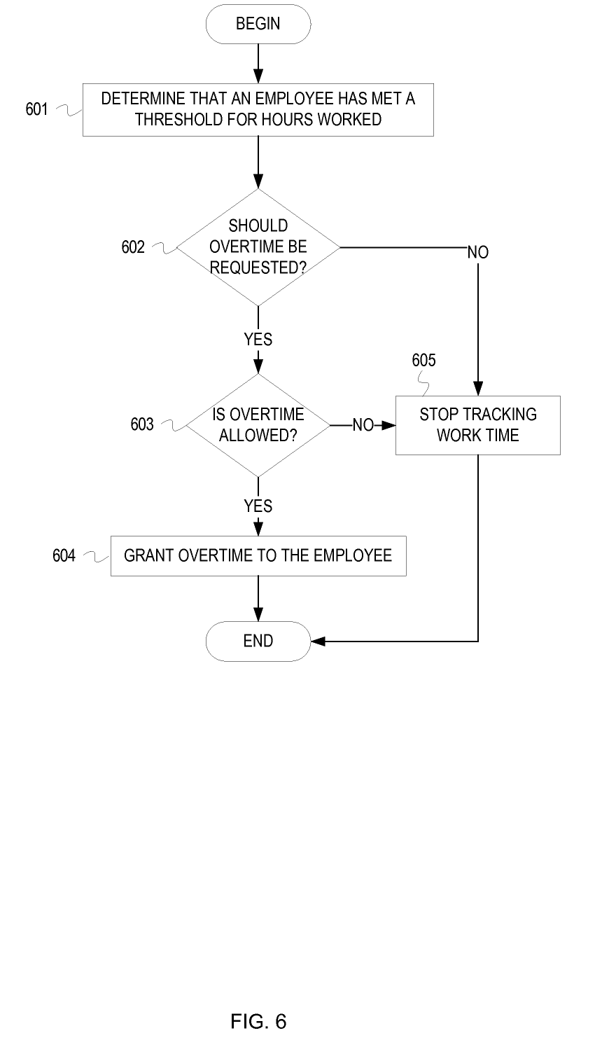

Employees may encounter situations in which they have to work overtime. For example, an employee may be approaching a crucial deadline. As another example, an employee may want to finish a big project prior to leaving on vacation. FIG. 6 depicts a flowchart of example operations for automatically managing overtime. Flow begins at block 601, where a work activity monitor determines that an employee has met a threshold for hours worked. For example, the employee has worked the maximum number of hours of the day or for the week. As another example, the employee has reached the number of hours budgeted to the employee for a particular project. Flow continues at block 602.

At block 602, the work activity monitor determines if overtime should be requested. Overtime may be requested automatically based on preferences. For example, the employee's work profile may indicate a preference to always request overtime when thresholds are reached. The work activity monitor may prompt the employee to determine if the employee desires to request overtime. If overtime should be requested, flow continues at block 603. If overtime should not be requested, overtime continues at block 605.

At block 603, the work activity monitor determines if overtime is allowed. Determining if overtime is allowed can be based on the employee's work profile. The work profile can indicate if overtime is allowed for the employee and may indicate specific overtime rules for the employee's projects. If overtime is allowed, flow continues at block 604. If overtime is not allowed, flow continues at block 605.

At block 604, the work activity monitor grants overtime to the employee and flow ends. The work activity monitor can continue tracking work time for projects.

At block 605, the work activity monitor stops tracking work time for projects.

In addition to overtime, employees may work an abnormal amount of time on a particular day. For example, an employee becomes ill and leaves work early. The daily work record may indicate a carryover amount of time that should be made up by the employee. If time is carried over to the end of a pay period, the carryover amount may be automatically subtracted from paid time off.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

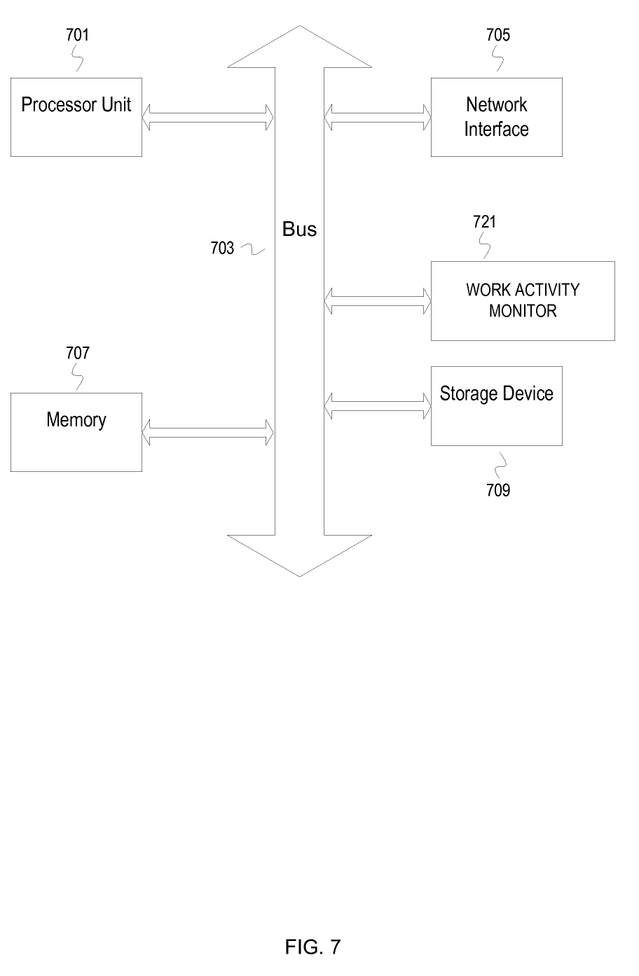

FIG. 7 depicts an example computer system. A computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709 (e.g., optical storage, magnetic storage, etc.). The computer system also includes a work activity monitor that detects activity, determines if the activity can be associated with a project, and tracks time for the project if the activity is associated with the project. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

While the embodiments are described with reference to various implementations and exploitations, it will be understood that these embodiments are illustrative and that the scope of the inventive subject matter is not limited to them. In general, techniques for automatically monitoring working hours for projects using instant messenger as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
receiving a work profile in response to an employee request to sign in to an instant messenger application, wherein the work profile is associated with an employee;
determining, based on the work profile, a plurality of applications to monitor for activity;
detecting an activity in a first of the plurality of applications;
determining that the activity is associated with a project indicated in the work profile;
computing an amount of time that the employee worked on the project, wherein the computing is based, at least in part, on a start time and an end time of the activity; and
recording the amount of time and an identifier of the project in a daily work record.

2. The method of claim 1, wherein the work profile comprises one or more of information about projects assigned to the employee, an indication of applications to monitor for activity associated with the projects, rules for associating activities with projects and overtime rules.

3. The method of claim 1, wherein the activity comprises at least one of creating a document, editing a document, composing an email, participating in a web conference, and instant messaging.

4. The method of claim 1, wherein said determining that the activity should be associated with the project indicated in the work profile is based on context of the activity, and input from the employee, wherein the context comprises at least one of text, a file name, a calendar entry, and a contact name indicated in the activity.

5. The method of claim 1, wherein said determining that the activity is associated with the project indicated in the work profile comprises displaying an indication of the project to the employee.

6. The method of claim 1 further comprising updating presence information of the employee to indicate that the employee is working on the project.

7. The method of claim 1 further comprising:
determining that an employee has met a threshold for hours worked;
determining that overtime should be requested;
determining that overtime is allowed for the employee based on the work profile; and
granting overtime to the employee.

8. A computer program product for automatically monitoring time associated with projects, the computer program product comprising:
a computer usable medium having computer usable program code embodied therewith, the computer usable program code comprising:
computer usable program code configured to,
receive a work profile in response to an employee request to sign in to an instant messenger application, wherein the work profile is associated with an employee;
determine, based on the work profile, a plurality of applications to monitor for activity;
detect an activity in a first of the plurality of applications;
determine that the activity is associated with a project indicated in the work profile;
compute an amount of time that the employee worked on the project, wherein the computing is based, at least in part, on a start time and an end time of the activity; and
record the amount of time and an identifier of the project in a daily work record.

9. The computer program product of claim 8, wherein the work profile comprises one or more of information about projects assigned to the employee, an indication of applications to monitor for activity associated with the projects, rules for associating activities with projects and overtime rules.

10. The computer program product of claim 8, wherein the activity comprises at least one of creating a document, editing a document, composing an email, participating in a web conference, and instant messaging.

11. The computer program product of claim 8, wherein the computer usable program code being configured to determine that the activity should be associated with the project indicated in the work profile is based on context of the activity, and input from the employee, wherein the context comprises at least one of text, a file name, a calendar entry, and a contact name indicated in the activity.

12. The computer program product of claim 8, wherein the computer usable program code being configured to determine that the activity is associated with the project indicated in the work profile comprises the computer useable program code being configured to display an indication of the project to the employee.

13. The computer program product of claim 8 comprises the computer usable program code being further configured to update presence information of the employee to indicate that the employee is working on the project.

14. The computer program product of claim 8 comprises the computer usable program code being further configured to:
determine that an employee has met a threshold for hours worked;
determine that overtime should be requested;
determine that overtime is allowed for the employee based on the work profile; and
grant overtime to the employee.

15. An apparatus comprising:
a processing unit;
a network interface; and
a work activity monitor operable to,
receive a work profile in response to an employee request to sign in to an instant messenger application, wherein the work profile is associated with an employee;
determine, based on the work profile, a plurality of applications to monitor for activity;
detect an activity in a first of the plurality of applications;
determine that the activity is associated with a project indicated in the work profile;
compute an amount of time that the employee worked on the project, wherein the computing is based, at least in part, on a start time and an end time of the activity; and
record the amount of time and an identifier of the project in a daily work record.

16. The apparatus of claim 15, wherein the work profile comprises one or more of information about projects assigned to the employee, an indication of applications to monitor for activity associated with the projects, rules for associating activities with projects and overtime rules.

17. The apparatus of claim 15, wherein the work activity monitor being operable to determine that the activity should be associated with the project indicated in the work profile is based on context of the activity, and input from the employee, wherein the context comprises at least one of text, a file name, a calendar entry, and a contact name indicated in the activity.

18. The apparatus of claim 15, wherein the work activity monitor being operable to determine that the activity is associated with the project indicated in the work profile comprises the work activity monitor being operable to display an indication of the project to the employee.

19. The apparatus of claim 15 comprises the work activity monitor being further operable to update presence information of the employee to indicate that the employee is working on the project.

20. The apparatus of claim 15 comprises the work activity monitor being further operable to:
determine that an employee has met a threshold for hours worked;
determine that overtime should be requested;
determine that overtime is allowed for the employee based on the work profile; and
grant overtime to the employee.
